(19) United States
(12) Patent Application Publication
(10) Pub. No.: US 2020/0332087 A1
(43) Pub. Date: Oct. 22, 2020

(54) A Lignin-Containing Cellulose Nanofiber, a Paper and a Film Comprising the Said Lignin-Containing Cellulose Nanofiber

(71) Applicant: SCG Packaging Public Company Limited, Bangkok (TH)

(72) Inventors: Pim-on Rujitanaroj, Bangkok (TH); Kasinee Thitiwutthisakul, Ratchaburi (TH); Phungjai Tinnasulanon, Nonthaburi (TH); Thipnakarin Boonfueng, Bangkok (TH); Nikorn Laocharoen, Nakhonpathom (TH); Ramiro Rojas, Hagersten (SE); Lars Berglund, Akersberga (SE)

(73) Assignee: SCG Packaging Public Company Limited, Bangkok (TH)

(21) Appl. No.: 16/954,608

(22) PCT Filed: Dec. 17, 2018
(86) PCT No.: PCT/TH2018/000054

§ 371 Date: Jun. 17, 2020

(30) Foreign Application Priority Data
Dec. 26, 2017 (TH) 1701007806

(51) Int. Cl. C08L 1/02; C08L 97/00; D21H 11/20; D21H 11/18; D21B 1/02; D21H 11/02; D21C 9/14; D21C 3/20; D21H 19/34

(52) U.S. Cl. CPC C08L 1/02; C08L 97/005; D21H 11/20; D21H 11/18; D21B 1/021; B82Y 40/00; D21C 9/14; D21C 3/20; D21H 19/34; C08L 2205/16; D21H 11/02

(57) ABSTRACT

The present invention relates to a lignin-containing cellulose nanofiber characterized in that (a) the said lignin-containing cellulose nanofiber has a content of carboxyl group in a range of 0.2-1.5 mmol/g, (b) the said lignin-containing cellulose nanofiber has Zeta potential in a range of −100 to −35 mV, and (c) the said lignin-containing cellulose nanofiber has an average diameter in a range of 3-30 nm. In addition, the present invention further relates to a paper and a film comprising the said lignin-containing cellulose nanofiber. The present invention also relates to a process for preparing a lignin-containing cellulose nanofiber comprising steps of (i) treating a lignin-containing cellulosic material with an organic solvent, (ii) treating the cellulosic material treated from the step (i) with derivative of N-oxy radical compound and hypochlorite compound, and (iii) mechanical treating the cellulosic material treated from the step (ii).

### FIELD OF THE INVENTION

This invention is in a chemical field relating to a lignin-containing cellulose nanofiber, a paper and a film comprising the said lignin-containing cellulose nanofiber.

### BACKGROUND OF THE INVENTION

A cellulose nanofiber produced from wood pulp is considered as a highly efficient natural reinforcing material which is used to produce various products to increase strength; for example, as an additive in paper or used to produce film, etc.

Generally, a cellulose nanofiber can be prepared by separating the cellulose nanofiber from wood pulp by using a mechanical disintegration method, but such method requires high energy which results in high production costs. Therefore, to reduce the use of energy in separating cellulose nanofiber from wood pulp, currently, there is an effort to create and develop new cellulose nanofiber preparation methods; for example, subjecting wood pulp to a chemical pretreatment or an enzymatic pretreatment to prepare a structure of wood pulp before subjecting it to the separation by mechanical disintegration method.

It is noted that preparing the cellulose nanofiber from a starting material being bleached pulp is easier to be done than preparing the same by using a starting material being unbleached pulp. This is because of lignin which is tight associated with polysaccharide like a net structure (cellulose and hemicellulose) remaining in the bleached pulp is considerably less when comparing to the unbleached pulp.

Prior arts disclosed the preparation of lignin-containing cellulose nanofiber and products comprising the said cellulose nanofiber by using different various methods are as the following examples.

US 2014/0154756 A1 disclosed a nanocellulose preparation process, including the cellulose nanofiber from lignocellulosic biomass by fractionating biomass with acids, solvents and water to obtain a cellulosic composition with crystallinity of up to 80% and a composition containing hemicellulose and lignin combined with each other before subjecting the same to a mechanical disintegration. The prepared nanocellulose product is used as a reinforcing agent in composite materials.

US 2015/0368441 A1 disclosed an oleophilic and hydrophobic nanocellulose material comprising lignin-coated cellulose nanofibrils or lignin-coated cellulose nanocrystals, whereby the said nanocellulose material is prepared by fractionating biomass with acids, solvents and water to obtain cellulose-rich solids and lignin-containing liquors before subjecting the said prepared solids to mechanical disintegration in the later steps.

US 2016/0168272 A1 disclosed a process for producing a nanocellulose-lignin composite material by subjecting a starting material to mechanical refining, wherein the said nanocellulose may be chemically or physically associated with the lignin and may have a content of lignin of up to 60% by weight.

However, even though there have been efforts to develop production processes of lignin-containing cellulose nanofiber as shown in the above examples of prior arts, the overall production processes still mainly use mechanical process without having disclosed a pretreatment of wood pulp using chemical treatment to obtain pulp suitable for treating with such mechanical process. Those processes require the relatively high use of energy in fiber separation. In addition, the prior arts did not disclose lignin-containing cellulose nanofiber, whereby lignin has a suitable dispersion both inside fiber and at the fibrous surface area.

### SUMMARY OF THE INVENTION

The present invention relates to a lignin-containing cellulose nanofiber characterized in that the said lignin-containing cellulose nanofiber has a content of carboxyl group in a range of 0.2-1.5 mmol/g, has Zeta potential in a range of −100 to −35 mV, and has an average diameter in a range of 3-30 nm. The said lignin-containing cellulose nanofiber is obtained from a process comprising steps of: (i) treating a lignin-containing cellulosic material with an organic solvent, (ii) treating the cellulosic material treated from the step (i) with derivative of N-oxy radical compound and hypochlorite compound, and (iii) mechanical treating the cellulosic material treated from the step (ii).

In addition, the present invention further relates to a paper and a film comprising the above lignin-containing cellulose nanofiber, whereby the said paper comprises a lignin-containing cellulose nanofiber characterized in that the said lignin-containing cellulose nanofiber has a content of carboxyl group in a range of 0.2-1.5 mmol/g, has Zeta potential in a range of −100 to −35 mV, and has an average diameter in a range of 3-30 nm, and

The said film comprises a lignin-containing cellulose nanofiber characterized in that the said lignin-containing cellulose nanofiber has a content of carboxyl group in a range of 0.2-1.5 mmol/g, has Zeta potential in a range of −100 to −35 mV, and has an average diameter in a range of 3-30 nm.

An objective of the present invention is to provide the lignin-containing cellulose nanofiber having several technical advantages, that are:

The lignin-containing cellulose nanofiber according to this invention which is prepared from the above process can effectively reduce the use of energy in the mechanical treatment step.

The lignin-containing cellulose nanofiber according to this invention which is prepared from the above process is characterized in that the said cellulose nanofiber comprises individualized nanofibers dispersed with cellulose nanofiber aggregates, whereby lignin is dispersed inside and on the surface of the said fiber.

The lignin-containing cellulose nanofiber according to this invention can be used as an additive for effectively reinforcing a paper. The paper comprising the lignin-containing cellulose nanofiber according to this invention has a burst index, a tensile index and a tensile stiffness index increasing to 10.3%, 15.7% and 27.7%, respectively, when comparing to the paper without any additive according to a test standard of ISO 1924-2: 2008 at a temperature of 27±1° C., at a relative humidity of 65±2%.

The lignin-containing cellulose nanofiber according to this invention can also be used for producing a film with a low oxygen transmission rate even in a condition of high relative humidity. The film comprising the lignin-containing cellulose nanofiber according to this invention has an oxygen transmission rate (OTR) in a range of 5 -7 cc.mm/m².day.atm at a temperature of 23±2° C., at a relative humidity of 90% according to a test standard of ASTM D3985.

Further, the film comprising the lignin-containing cellulose nanofiber according to this invention has increased modulus of elasticity, tensile strength and strain at break. That is, the film comprising the lignin-containing cellulose nanofiber according to this invention has an increased modulus of elasticity of 14.3%, an increased tensile strength of 42.9% and an increased strain at break of 25%, when comparing to the film obtained from the cellulose nanofiber that does not contain lignin according to a test standard of ASTM D882.

### BRIEF DESCRIPTION OF THE DRAWINGS

FIG. 1 is a photograph from a scanning electron microscope (SEM) at 400× magnification showing fiber characteristics of (a) semi-chemical pulp subjected to an oxidation, (b) semi-chemical pulp subjected to the 1^{st} mechanical treatment at 800 PSI, and (c) semi-chemical pulp subjected to the 7^{th} mechanical treatment at 1,800 PSI.

FIG. 2 is a photograph from an atomic-force microscope (AFM) showing characteristics of the lignin-containing cellulose nanofiber according to this invention at a size of (a) 10×10 μm² and (b) 3×3 μm².

FIG. 3 is a photograph from an atomic-force microscope (AFM) showing dispersion characteristics of lignin in the lignin-containing cellulose nanofiber according to this invention at a size of 10×10 μm².

FIG. 4 is a graph showing a modulus of elasticity of the paper having the lignin-containing cellulose nanofiber according to this invention at contents of 0, 5 and 10% by weight based on dry weight of paper.

FIG. 5 is a graph showing a stress at break of the paper having the lignin-containing cellulose nanofiber according to this invention at contents of 0, 5 and 10% by weight based on dry weight of paper.

FIG. 6 is a graph showing a strain at break of the paper having the lignin-containing cellulose nanofiber according to this invention at contents of 0, 5 and 10% by weight based on dry weight of paper.

FIG. 7 is a graph showing increased percentage of a burst index, a tensile index, a tensile stiffness index and a ring crush test of the paper comprising the lignin-containing cellulose nanofiber according to this invention and the paper comprising the lignin-coated cellulose nanofiber, whereby the content of cellulose nanofiber is equal to 5% by weight based on dry weight of paper, when comparing to the paper without any additive.

FIG. 8 is a graph showing the oxygen transmission rate of (A) the film produced from lignin-containing cellulose nanofiber according to this invention, (B) the film produced from cellulose nanofiber made from bleached pulp, and (C) the film produced from cellulose nanofiber made from lignin-coated bleached pulp.

### DETAILED DESCRIPTION OF THE INVENTION

The following will further describe more apparent specifications related to the present invention.

According to this invention, unless indicated otherwise, “percentage (%)” indicating a content of substance, material or fiber shown herein means % by weight, except in case of percentage or increasing percentage of various properties of material; namely, modulus of elasticity, stress at break, strain at break, tensile strength, ring crush test, burst index, tensile index and tensile stiffness index.

According to this invention, the terms “semi-chemical pulp”, “chemi-thermo mechanical pulp” and “unbleached pulp” refer to types of pulp obtained from a production process which is well known in the art; for example,

“Semi-chemical pulp” according to this invention means to include, but not limited only to, the pulp obtained from a production process which uses chemicals and mechanical energy together in the fiber fractionation, whereby the content of chemicals used in the production process is less when comparing to the chemical pulp.

“Chemi-thermo mechanical pulp” according to this invention means to include, but not limited only to, the pulp obtained from a production process which uses chemicals together with thermal energy to starting material before subjecting it to the mechanical grinding in the fiber fractionation.

“Unbleached pulp” according to this invention means to include, but not limited only to, any pulp that is not subjected to bleaching.

1. Lignin-Containing Cellulose Nanofiber

The lignin-containing cellulose nanofiber according to this invention is characterized in that:
(a) the said lignin-containing cellulose nanofiber has the content of carboxyl group in the range of 0.2-1.5 mmol/g
(b) the said lignin-containing cellulose nanofiber has Zeta potential in the range of −100 to −35 mV, and
(c) the said lignin-containing cellulose nanofiber has the average diameter in the range of 3-30 nm.

According to this invention, the said lignin-containing cellulose nanofiber preferably has the content of carboxyl group in the range of 0.4-0.7 mmol/g.

According to this invention, the said lignin-containing cellulose nanofiber preferably has Zeta potential in the range of −80 to −25 mV.

According to this invention, the said lignin-containing cellulose nanofiber preferably has the average diameter in the range of 5-21 nm.

According to this invention, the said lignin-containing cellulose nanofiber has a content of lignin in a range of 19-25% by weight, preferably in the range of 22-24% by weight.

According to this invention, the said lignin-containing cellulose nanofiber comprises individualized cellulose nanofibers having sizes ranging from 2-6 nm and cellulose nanofiber aggregates having sizes ranging from 23-32 nm.

According to this invention, the said lignin-containing cellulose nanofiber is obtained from the process comprising steps of:
(i) treating the lignin-containing cellulosic material with the organic solvent
(ii) treating the cellulosic material treated from the step (i) with derivative of N-oxy radical compound and hypochlorite compound, and
(iii) mechanical treating the cellulosic material treated from the step (ii).

According to this invention, the said lignin-containing cellulosic material can be selected from semi-chemical pulp, chemi-thermomechanical pulp or mechanical pulp.

According to this invention, preferably, the said lignin-containing cellulosic material is semi-chemical pulp or chemi-thermomechanical pulp having the content of lignin in a range of 25-30% by weight.

According to this invention, the said lignin-containing cellulosic material is unbleached pulp.

According to this invention, in the above process, the step (i) is performed by extracting the said lignin-containing cellulosic material by using the organic solvent and washing with water at an ambient temperature or at a higher temperature. Preferably, washing with water is carried out at a temperature in a range of 70-100° C.

According to this invention, the organic solvent used in the step (i) can be selected from ethanol, benzene, dichloromethane, acetone or a mixed solvent obtained from the said solvents. Preferably, the organic solvent is acetone.

According to this invention, in the above process, the step (ii) is performed by using a mole ratio of derivative of N-oxy radical compound to lignin-containing cellulosic material in a range of 0.15-0.25.

According to this invention, in the above process, the step (ii) is performed by using a mole ratio of derivative of N-oxy radical compound to hypochlorite compound in a range of 0.15-0.25.

According to this invention, the said derivative of N-oxy radical compound is derivative of 2,2,6,6-tetramethylpiperidine-1-oxy radical selected from 4-acetamido-(2,2,6,6-tetramethylpiperidine-1-oxy radical) or 4-methoxy-2,2,6,6-tetramethylpiperidine-1-oxyl.

Preferably, the said derivative of 2,2,6,6-tetramethylpiperidine-1-oxy radical is 4-acetamido-(2,2,6,6-tetramethylpiperidine-1-oxy radical).

According to this invention, in the above process, hypochlorite compound in the step (ii) is alkali metal hypochlorite selected from sodium hypochlorite (NaOCl) or calcium hypochlorite (Ca(OCl)₂), preferably the alkali metal hypochlorite is sodium hypochlorite.

According to this invention, in the above process, the step (iii) is performed by applying high shear rate to the cellulosic material obtained from the step (ii) by using high pressure homogenization.

According to this invention, the cellulose nanofiber obtained from the above process is used as an additive in a paper production process or used as an additive in coating or used for producing film.

2. Paper Comprising Lignin-Containing Cellulose Nanofiber

The paper comprising the lignin-containing cellulose nanofiber according to this invention is characterized in that:
(a) the said lignin-containing cellulose nanofiber has the content of carboxyl group in the range of 0.2-1.5 mmol/g
(b) the said lignin-containing cellulose nanofiber has Zeta potential in the range of −100 to −35 mV, and
(c) the said lignin-containing cellulose nanofiber has the average fiber diameter in the range of 3-30 nm.

According to this invention, preferably the paper comprising the said lignin-containing cellulose nanofiber has the content of carboxyl group in fiber in the range of 0.4-0.7 mmol/g.

According to this invention, preferably the paper comprising the said lignin-containing cellulose nanofiber has Zeta potential of fiber in the range of −80 to −25 mV.

According to this invention, preferably the paper comprising the said lignin-containing cellulose nanofiber has the fiber diameter in the range of 5-21 nm.

According to this invention, the paper comprising the said lignin-containing cellulose nanofiber has the content of lignin in fiber in the range of 19-25% by weight, preferably in the range of 22-24% by weight.

The lignin present in the lignin-containing cellulose nanofiber according to this invention has some parts dispersed in the fiber and some parts integrated as lignin agglomerates dispersing on the surface of the fiber/on the fiber surface.

According to this invention, the paper comprising the said lignin-containing cellulose nanofiber wherein the said lignin-containing cellulose nanofiber comprises individualized cellulose nanofibers having sizes ranging from 2-6 nm and cellulose nanofiber aggregates having sizes ranging from 23-32 nm.

According to this invention, the paper comprising the said lignin-containing cellulose nanofiber wherein the said lignin-containing cellulose nanofiber is obtained from the process comprising steps of:
(i) treating the lignin-containing cellulosic material with the organic solvent
(ii) treating the cellulosic material treated from the step (i) with derivative of N-oxy radical compound and hypochlorite compound, and
(iii) mechanical treating the cellulosic material treated from the step (ii).

According to this invention, the paper comprising the lignin-containing cellulose nanofiber which is obtained from the above process, wherein the lignin-containing cellulosic material used in the said process is selected from semi-chemical pulp, chemi-thermomechanical pulp or mechanical pulp.

Preferably, the lignin-containing cellulosic material used in the said process is semi-chemical pulp or chemi-thermomechanical pulp having the content of lignin in the range of 25-30% by weight.

According to this invention, the paper comprising lignin-containing cellulose nanofiber which is obtained from the above process, wherein the lignin-containing cellulosic material used in the said process is unbleached pulp.

According to this invention, the paper comprising the lignin-containing cellulose nanofiber which is obtained from the above process, wherein the step (i) in the said process is performed by extracting the said lignin-containing cellulosic material by using the organic solvent and washing with water at the ambient temperature or a higher temperature. Preferably, washing with water in the said step (i) can be carried out at the temperature in the range of 70-100° C.

According to this invention, the organic solvent used in the step (i) can be selected from ethanol, benzene, dichloromethane, acetone or the mixed solvent obtained from the said solvents. Preferably, the organic solvent is acetone.

According to this invention, the paper comprising the lignin-containing cellulose nanofiber which is obtained from the above process, wherein the step (ii) in the said process is performed by using the mole ratio of derivative of N-oxy radical compound to cellulosic material in the range of 0.15-0.25.

According to this invention, the paper comprising the lignin-containing cellulose nanofiber which is obtained from the above process, wherein the step (ii) in the said process is performed by using a mole ratio of derivative of N-oxy radical compound to hypochlorite compound in a range of 0.15-0.25.

According to this invention, the paper comprising the lignin-containing cellulose nanofiber which is obtained from the above process, wherein derivative of N-oxy radical compound used in the said step (ii) is derivative of 2,2,6,6-tetramethylpiperidine-1-oxy radical selected from 4-acetamido-(2,2,6,6-tetramethylpiperidine-1-oxy radical) or 4-methoxy-2,2,6,6-tetramethylpiperidine-1-oxyl.

Preferably, the said derivative of 2,2,6,6-tetramethylpiperidine-1-oxy radical is 4-acetamido-(2,2,6,6-tetramethylpiperidine-1-oxy radical).

According to this invention, the paper comprising the lignin-containing cellulose nanofiber which is obtained from the above process, wherein hypochlorite compound in the step (iii) is alkali metal hypochlorite selected from sodium hypochlorite (NaOCl) or calcium hypochlorite (Ca(OCl)₂).

According to this invention, the paper comprising the lignin-containing cellulose nanofiber which is obtained from the above process, wherein the step (iii) is performed by applying high shear rate to the cellulosic material obtained from the step (ii) by using high pressure homogenization.

According to this invention, the paper comprising the said lignin-containing cellulose nanofiber in the content in the range of 1-10% by weight, preferably in the range of 5-10% by weight based on dry weight of paper.

According to this invention, the paper comprising the lignin-containing cellulose nanofiber has a burst index in a range of 2.0-3.5 kPa·m²/g.

According to this invention, the paper comprising the lignin-containing cellulose nanofiber has a tensile index in a range of 35-45 Nm/g.

According to this invention, the paper comprising the lignin-containing cellulose nanofiber has a tensile stiffness index in a range of 2,300-3,200 Nm/g.

3. Film Comprising Lignin-Containing Cellulose Nanofiber

The film comprising the lignin-containing cellulose nanofiber according to this invention is characterized in that:
(a) the said lignin-containing cellulose nanofiber has the content of carboxyl group in the range of 0.2-1.5 mmol/g
(b) the said lignin-containing cellulose nanofiber has Zeta potential in the range of −100 to −35 mV, and
(c) the said lignin-containing cellulose nanofiber has the average fiber diameter in the range of 3-30 nm.

According to this invention, preferably, the film comprising the said lignin-containing cellulose nanofiber has the content of carboxyl group in the said fiber in the range of 0.4-0.7 mmol/g.

According to this invention, the film comprising the said lignin-containing cellulose nanofiber preferably has Zeta potential of the said fiber in the range of −80 to −25 mV.

According to this invention, the film comprising the said lignin-containing cellulose nanofiber preferably has the average diameter of the said fiber in the range of 5-21 nm.

According to this invention, the film comprising the said lignin-containing cellulose nanofiber has the content of lignin in the said fiber in the range of 19-25% by weight, preferably in the range of 22-24% by weight.

According to this invention, the film comprising the said lignin-containing cellulose nanofiber, wherein the lignin-containing cellulose nanofiber comprises individualized cellulose nanofibers having sizes ranging from 2-6 nm and cellulose nanofiber aggregates having sizes ranging from 23-32 nm.

According to this invention, the film comprising the lignin-containing cellulose nanofiber, wherein the lignin-containing cellulose nanofiber is obtained from the process comprising steps of:
(i) treating the lignin-containing cellulosic material with the organic solvent
(ii) treating the cellulosic material treated from the step (i) with derivative of N-oxy radical compound and hypochlorite compound, and
(iii) mechanical treating the cellulosic material treated from the step (ii).

According to this invention, the film comprising the lignin-containing cellulose nanofiber which is obtained from the above process, wherein the lignin-containing cellulosic material used in the said process is selected from semi-chemical pulp, chemi-thermomechanical pulp or mechanical pulp.

Preferably, the lignin-containing cellulose material used in the said process is semi-chemical pulp or chemi-thermomechanical pulp having the content of lignin in the range of 22-24% by weight.

According to this invention, the film comprising the lignin-containing cellulose nanofiber which is obtained from the above process, wherein the said semi-chemical pulp is unbleached pulp.

According to this invention, the film comprising the lignin-containing cellulose nanofiber which is obtained from the above process, wherein the step (i) is performed by extracting the said lignin-containing cellulosic material by using the organic solvent and washing with water in the ambient temperature or the higher temperature. Preferably, washing with water is carried out at the temperature in a range of 70-100° C.

According to this invention, the film comprising lignin-containing cellulose nanofiber which is obtained from the above process, wherein the organic solvent used in the step (i) can be selected from ethanol, benzene, dichloromethane, acetone or the mixed solvent obtained from the said solvents. Preferably, the organic solvent is acetone.

According to this invention, the film comprising the lignin-containing cellulose nanofiber which is obtained from the above process, wherein the step (ii) is performed by using the mole ratio of derivative of N-oxy radical compound to cellulosic material in the range of 0.15-0.25.

According to this invention, the film comprising the lignin-containing cellulose nanofiber which is obtained from the above process, wherein the step (ii) is performed by using the mole ratio of derivative of N-oxy radical compound to hypochlorite compound in the range of 0.15-0.25.

According to this invention, the film comprising the lignin-containing cellulose nanofiber which is obtained from the above process, wherein the said derivative of N-oxy radical compound is derivative of 2,2,6,6-tetramethylpiperidine-1-oxy radical selected from 4-acetamido-(2,2,6,6-tetramethylpiperidine-1-oxy radical) or 4-methoxy-2,2,6,6 tetramethylpiperidine-1-oxyl.

Preferably, the said derivative of N-oxy radical compound is derivative of 2,2,6,6-tetramethylpiperidine-1-oxy radical or 4-acetamido-(2,2,6,6-tetramethylpiperidine-1-oxy radical).

According to this invention, the film comprising the lignin-containing cellulose nanofiber which is obtained from the above process, wherein hypochlorite compound in the step (iii) is alkali metal hypochlorite selected from sodium hypochlorite or calcium hypochlorite (Ca(OCl)₂). Preferably, the alkali metal hypochlorite is sodium hypochlorite.

According to this invention, the film comprising the lignin-containing cellulose nanofiber which is obtained from the above process, wherein the step (iii) is performed by applying high shear rate to the cellulosic material obtained from the step (ii) by using high pressure homogenization.

According to this invention, the film comprising the above lignin-containing cellulose nanofiber has a modulus of elasticity in a range of 9-15 GPa.

According to this invention, the film comprising the above lignin-containing cellulose nanofiber has a tensile strength in a range of 170-190 MPa.

According to this invention, the film comprising the above lignin-containing cellulose nanofiber has a strain at break in a range of 2.0-4.0%.

According to this invention, the film comprising the above lignin-containing cellulose nanofiber has an oxygen transmission rate (OTR) in a range of 5-7 cc.mm/m².day.atm at a temperature of 23° C. in a relative humidity of 90%.

### EXAMPLES

The following will further explain the present invention by way of examples. However, these examples are not considered as limiting the scope of the present invention.

1. Preparation of Lignin-Containing Cellulose Nanofiber

Examples of lignin-containing cellulose nanofiber according to this invention can be prepared by mixing semi-chemical pulp with water in a content of 2% by pulp weight. Then, subjecting the resulting mixture(s) to a pulp disintegrator and thereby subjecting the obtained pulp to a process comprising the following steps:
(i) extracting a semi-chemical pulp with different types of solvents as shown in Table 1
(ii) subjecting the said extracted semi-chemical pulp to an oxidation by using 4-acetamido-(2,2,6,6-tetramethylpiperidine-1-oxy radical) and reacting with sodium hypochlorite, and
(iii) subjecting the pulp subjected the reaction in the step (ii) to a mechanical grinding using high pressure homogenization.

2. Analysis of Characteristics of Semi-Chemical Pulp Treated in Each Step of the Above Process

Examples of semi-chemical pulp treated in each step of the above process will be analyzed to find out a content of decreased lignin by comparing it to the starting semi-chemical pulp that has not been subjected any treatment.

2.1 Step (i): Extracting Pulp with a Solvent

Examples of semi-chemical pulp that has been extracted by different solvents are subjected to be analyzed to find out a content of lignin (Klason lignin content). According to the TAPPI T222 standard, it has been found that the semi-chemical pulp extracted by acetone followed by washing with hot water (acetone-hot water) has a highest content of lignin remaining in the pulp, when comparing to the pulp extracted by other types of solvents. The analysis result is shown in Table 1.

Table 1 shows the analysis result of contents of components of semi-chemical pulp extracted by different types of solvents (and optionally followed by washing with water) 4 times comparing to the pulp that has not been extracted by any solvent.

| | Component (%) | | | | | | |
|---|---|---|---|---|---|---|---|
| Examples | Arabinose | Galactose | Glucose | Mannose | Xylose | Rhamnose | Lignin |
| semi-chemical | 0.35 | 1.50 | 59.78 | 0.54 | 6.98 | 0.10 | 28.45 |
| pulp not | | | | | | | |
| extracted by | | | | | | | |
| using any solvent | | | | | | | |
| semi-chemical | 0.33 | 1.07 | 65.56 | 0.53 | 7.11 | 0.06 | 25.35 |
| pulp extracted by | | | | | | | |
| using acetone- | | | | | | | |
| water¹ | | | | | | | |
| semi-chemical | 0.33 | 1.08 | 65.13 | 0.41 | 6.94 | 0.06 | 25.49 |
| pulp extracted by | | | | | | | |
| using acetone- | | | | | | | |
| hexane² | | | | | | | |
| semi-chemical | 0.34 | 1.08 | 65.54 | 0.52 | 7.12 | 0.06 | 26.05 |
| pulp extracted by | | | | | | | |
| using acetone-hot | | | | | | | |
| water³ | | | | | | | |

¹Extracting by using acetone-water refers to extracting by using acetone and followed by washing with water at the ambient temperature.
²Extracting by using acetone-hexane refers to extracting by using acetone and followed by extracting by using hexane.
³Extracting by using acetone-hot water refers to extracting by acetone and followed by washing with hot water or water with a higher temperature than an ambient temperature.

2.2 Step (ii): Treating the Pulp with Derivative of 2,2,6,6-tetramethylpiperidine-1-oxy Radical Compound and Sodium Hypochlorite

Examples of pulp extracted by the above different types of solvents (10 g) will be subjected to oxidation by using a catalyst as 4-acetamido-(2,2,6,6-tetramethylpiperidine-1-oxy radical) in a content of 60-100 μmol to pulp of 1 g and reacting with sodium hypochlorite in a content of 4-8 mmol to pulp of 1 g, respectively.

When subjecting the pulp obtained from the above reaction to be analyzed to find a content of lignin by using the method according to the TAPPI T222 standard, it has been found that the content of lignin present in the pulp extracted by acetone and washed with hot water and oxidation has a slight decrease in lignin (the lignin content is 22.93%) when comparing to semi-chemical pulp not extracted by using any solvent (the lignin content is 28.45%) and semi-chemical pulp extracted by using acetone and washed with hot water alone (the lignin content is 26.05%).

2.3 Step (iii): Mechanical Treating the Pulp

Examples of the semi-chemical pulp extracted and subjected to the above oxidation will be subjected to mechanical treatment steps by using high pressure homogenization 7 times by using a pressure of 800 PSI when reducing the size of chamber from 400 μm until 200 μm respectively and using a pressure of 1,800 PSI when reducing the size of chamber from 200 μm until 100 μm, respectively. When this step is completed, the lignin-containing cellulose nanofiber according to this invention will be obtained.

According to this invention, extracting the pulp by using acetone and washing with hot water helps eliminate unwanted extractives and fines from the pulp. Such step is to prepare the fiber surface to facilitate fractionating of cellulose nanofibers by using mechanical treatment which helps reduce energy used in the production process of cellulose nanofiber. The semi-chemical pulp treated from the step (i): extracting by acetone and washing with hot water and the step (ii) of treating the pulp with derivative of 2,2,6,6-tetramethylpiperidine-1-oxy radical compound and sodium hypochlorite according to this invention uses mechanical energy at about 3,000 kWh, while semi-chemical pulp which is not subjected to any steps uses higher mechanical shear rate at about 2.2 times (6,500 kWh).

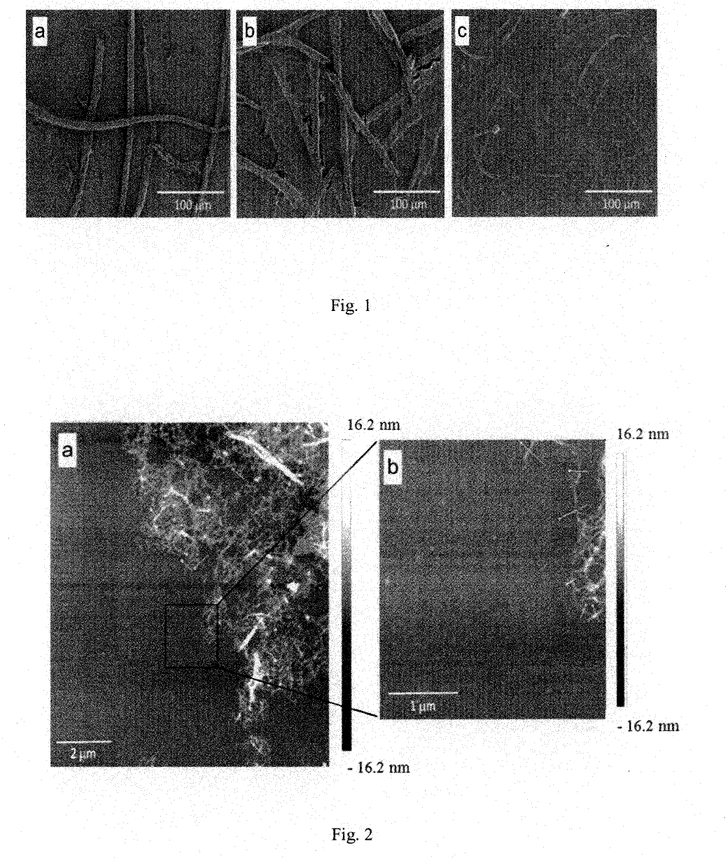

When subjecting the cellulose nanofiber obtained from the mechanical treatment step to analyze the fiber characteristics by using a Scanning Electron Microscope (SEM), the analysis result shown in FIG. 1, whereby (a) is semi-chemical pulp subjected to the oxidation, (b) is semi-chemical pulp subjected to the 1^{st} mechanical treatment at 800 PSI and (c) is semi-chemical pulp subjected the 7^{th} mechanical treatment at 1,800 PSI.

From the analysis result, it has been found that the cellulose nanofiber obtained from subjecting semi-chemical pulp to be extracted by acetone-hot water in the step (i) and followed by the reaction in the step (ii) consists of long and porous fibers and has a fiber diameter in a range of about 10-15 μm (FIG. 1a), and when subjecting the said pulp to the 1^{st} mechanical treatment (pressure of 800 PSI), the pulp starts to disintegrate and fibers have a shortened length (FIG. 1b) until the pulp subjected to the 7^{th} mechanical treatment (pressure 1,800 PSI), the resulting cellulose nanofiber has only 100 μm of length and has a fiber diameter in a level of μm to nm (FIG. 1c).

In addition, when subjecting the cellulose nanofiber to the mechanical treatment in the step (iii) to further analyze for finding a fiber diameter size by using an atomic-force microscope (AFM) of which the result is as shown in FIGS. 2a and 2b. It has been found that the prepared cellulose nanofiber according to this invention has regularly dispersion of fibers, has the size of the average diameter in a range of 5-21 nm. The said cellulose nanofiber comprises individualized cellulose nanofibers having the diameter of about 2-6 nm, which is dispersed with cellulose nanofiber aggregates having a diameter of about 23-32 nm.

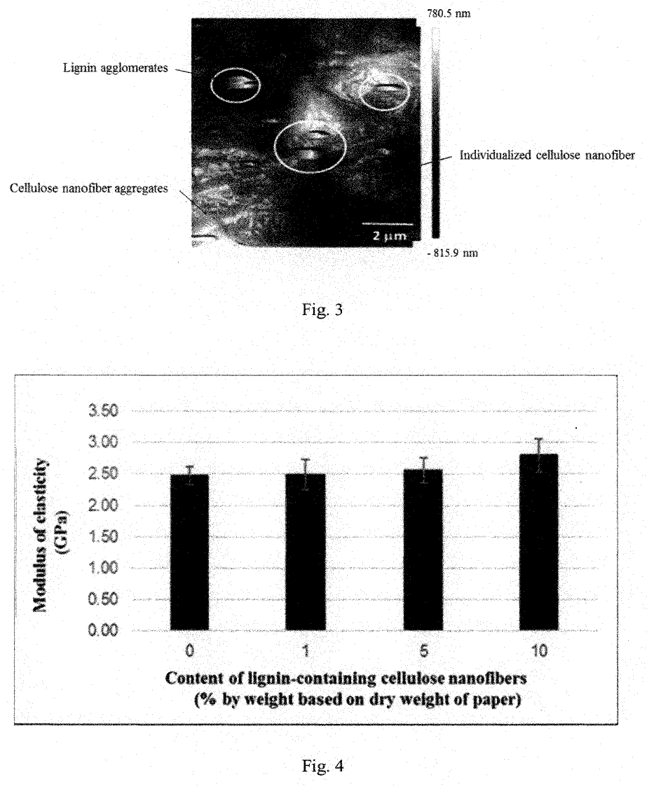

From the AFM technique, it has also been found that the cellulose nanofiber according to this invention contains lignin dispersed in some parts of fibers and some parts of lignin integrated as agglomerates which are dispersed on the fiber surface. The said lignin agglomerates have diameter sizes in the range of 24-38 nm. The analysis result is shown in FIG. 3.

In addition, examples of the cellulose nanofiber obtained from the process according to this invention are further analyzed to find a content of carboxyl group by using the Conductometric titration technique and find Zeta potential (SZP) of the fiber by using Zetasiser ZEN3600 of which the result is shown in Table 3.

Table 3 shows the content of carboxyl group, Zeta potential and the content of lignin present in different types of cellulose nanofibers.

| | content of | | |
|---|---|---|---|
| | carboxyl | Zeta | content |
| | group | potential | of lignin |
| Examples | (mmol/g) | (mV) | (%) |
| lignin-containing cellulose | 0.4-0.7 | −80 to −25 | 22-24 |
| nanofiber according to this | | | |
| invention | | | |
| cellulose nanofiber filled | N/A | −25 to −15 | 22 |
| with lignin | | | |
| commercial cellulose | N/A | −20 to −15 | <0.5 |
| nanofiber Type 1 | | | |
| commercial cellulose | N/A | −20 to −15 | <0.5 |
| nanofiber Type 1 | | | |

From the analysis result, it has been found that the lignin-containing cellulose nanofiber according to this invention gives significantly more Zeta potential when comparing with the cellulose nanofiber filled with lignin at the same content and the commercial cellulose nanofibers Type 1 and Type 2 with a lower content of lignin.

3. Use of Lignin-Containing Cellulose Nanofiber According to this Invention as an Additive in the Paper 3.1. Finding an Appropriate Content of the Lignin-Containing Cellulose Nanofiber

Examples of the paper produced from recycled pulp having the lignin-containing cellulose nanofiber according to this invention with contents of 0, 1, 5, and 10% by weight based on dry weight of paper are subjected to a test to find a modulus of elasticity, a stress at break and a strain at break by using an assay according to the ASTM D882 standard as shown in FIGS. 4, 5 and 6, respectively.

From FIG. 4, it can be seen that using the content of lignin-containing cellulose nanofiber according to this invention at 5% by weight based on dry weight of paper increases the modulus of elasticity of paper, and using at 10% by weight based on dry weight of paper notably increases the modulus of elasticity of paper.

From FIG. 5, it can be seen that the paper comprising the lignin-containing cellulose nanofiber according to this invention with a content of 5% and 10% by weight based on dry weight of paper respectively has a significant increase in the stress at break.

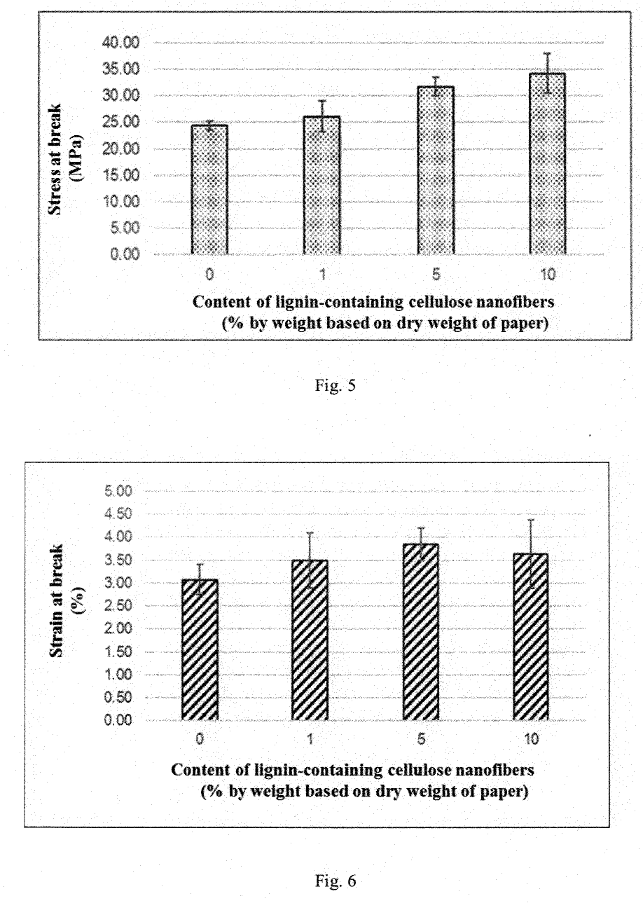

From FIG. 6, it can be seen that the lignin-containing cellulose nanofiber according to this invention increase the strain at break in paper for every content, whereby the content of lignin-containing cellulose nanofiber according to the invention that provides the highest value of strain at break is 5% by weight based on dry weight of paper.

3.2. Effects of Type of the Cellulose Nanofiber to Paper Strength

Examples of the paper produced from recycled pulp comprises different types of cellulose nanofibers (e.g. the lignin-containing cellulose nanofiber according to this invention, the commercial cellulose nanofiber Type 1 and the commercial cellulose nanofiber Type 2) with a content of 10% by weight based on dry weight of paper is subjected to a test for finding a burst index, a tensile index and a tensile stiffness index by using an assay according to the ISO 1924-2: 2008 standard as shown in Table 4.

Table 4 shows a burst index, a tensile index and a tensile stiffness index of the paper comprising different types of cellulose nanofibers.

| | | | Tensile |
|---|---|---|---|
| | Burst | Tensile | stiffness |
| | index | index | index |
| Types of paper | (kPa · m²/g) | (Nm/g) | (Nm/g) |
| Paper comprising lignin-containing | 3.22 | 47.1 | 3225 |
| cellulose nanofiber according to | | | |
| this invention | | | |
| Paper comprising the commercial | 3.03 | 44.3 | 2852 |
| cellulose nanofiber Type 1 | | | |
| Paper comprising the cellulose | 3.12 | 44.1 | 3057 |
| nanofiber Type 2 | | | |
| Paper without any additive | 2.9 | 40.5 | 2450 |

From the test result, it has been found that the paper comprising the lignin-containing cellulose nanofiber according to this invention increases the burst index, tensile index and tensile stiffness index of the paper up to 10.3%, 15.7% and 27,7% respectively, when comparing to the paper produced from recycled pulp without any additive. The said increased values are more than those of the commercial cellulose nanofibers Type 1 and Type 2.

In addition, when subjecting examples of the paper produced from recycled pulp comprising the said lignin-containing cellulose nanofiber according to this invention and examples of the paper produced from recycled pulp comprising the lignin-coated cellulose nanofiber to a test to compare the burst index, tensile index, tensile stiffness index and ring crush test by using an assay according to the ISO 1924-2: 2008 standard by controlling contents of both types of cellulose nanofibers at 5% by weight based on dry weight of paper. The test result is shown in Table 5.

Table 5 shows the burst index, tensile index, tensile stiffness index and ring crush test of the paper.

| | | | Tensile | Ring |
|---|---|---|---|---|
| | Burst | Tensile | stiffness | crush |
| | index | index | index | test |
| Types of paper | (kPa · m²/g) | (Nm/g) | (Nm/g) | (newton) |
| Paper comprising | 2.19 | 37.2 | 2650 | 312 |
| lignin-containing | | | | |
| cellulose nanofiber | | | | |
| according to | | | | |
| this invention | | | | |
| Paper comprising | 2.28 | 35.8 | 2494 | 304 |
| lignin-coated | | | | |
| cellulose nanofiber | | | | |
| Paper without any | 2.12 | 33.4 | 2257 | 261 |
| additive | | | | |

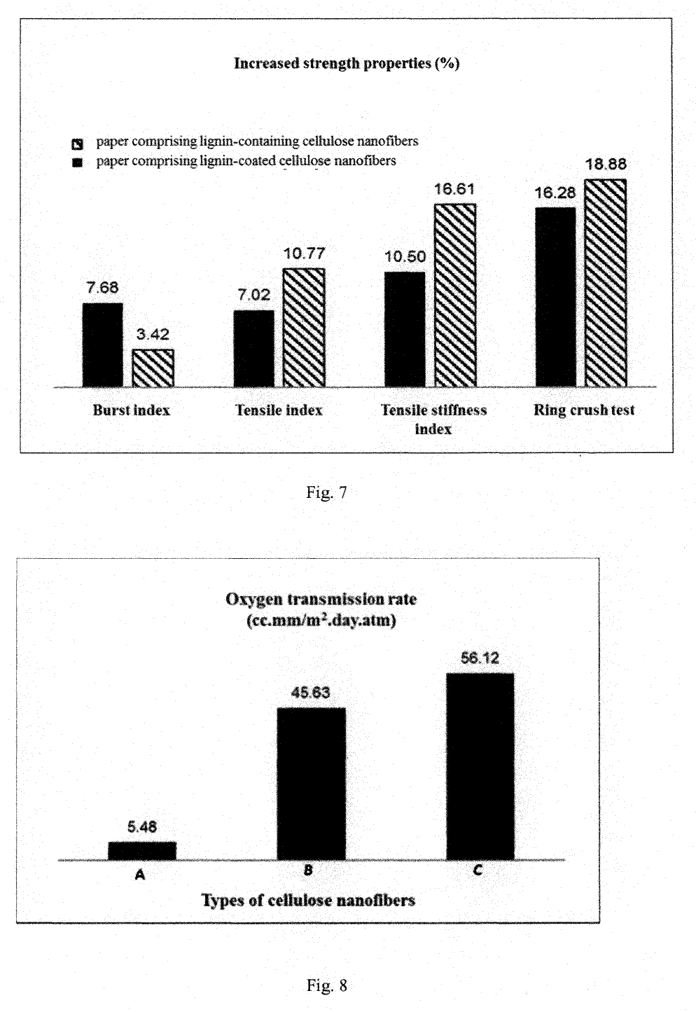

From the test result, it has been found that the paper comprising the lignin-containing cellulose nanofiber according to this invention has the tensile index, tensile stiffness index and ring crush test increasing to 10.77%, 16.61% and 18.88% respectively, when comparing to the paper produced from recycled pulp without any additive. The said increased values are more than those of the paper comprising the lignin-coated cellulose nanofiber (FIG. 7).

4. Use of the Lignin-Containing Cellulose Nanofiber According to This Invention for Producing the Film

Examples of the film produced from different types of cellulose nanofiber, e.g. (A) lignin-containing cellulose nanofiber according to this invention, (B) cellulose nanofiber made from bleached pulp, and (C) cellulose nanofiber obtained from lignin-coated bleached pulp will be tested according to the ASTM D3985 standard to compare an oxygen transmission rate at a temperature of 23° C. at a relative humidity of 90% of the said three types of films.

As shown in FIG. 8, from the test result, it has been found that the film produced from the lignin-containing cellulose nanofiber according to this invention has an oxygen transmission rate of 5.48 cc.mm/m².day.atm. The said transmission rate is significantly lower than that obtained from the film produced from bleached cellulose nanofiber and the film produced from cellulose nanofiber made from lignin-coated bleached pulp.

Furthermore, when subjecting the film comprising lignin-containing cellulose nanofiber according to this invention to a test for finding the modulus of elasticity, tensile strength and strain at break by using an assay according to the ASTM D882 standard at a temperature of 23±2° C. at a relative humidity of 50±10%, when comparing to the film made from the cellulose nanofiber obtained from the lignin-coated bleached pulp. The test result is shown in Table 6.

Table 6 shows the modulus of elasticity, tensile strength and strain at break of the film comprising different types of cellulose nanofibers.

| | Modulus | | Strain |
|---|---|---|---|
| | of | Tensile | at |
| | elasticity | strength | break |
| Types of cellulose nanofibers | (GPa) | (MPa) | (%) |
| Lignin-containing cellulose | 12 | 180 | 3.5 |
| nanofiber according to this | | | |
| invention | | | |
| cellulose nanofiber obtained | 10.5 | 126 | 2.8 |
| from lignin-coated bleached | | | |
| pulp | | | |

From the test, it has been found that the film comprising the lignin-containing cellulose nanofiber according to this invention has the modulus of elasticity increasing to 14.3%, tensile strength increasing to 42.9% and a strain at break increasing to 25%, when comparing to the film made from the cellulose nanofiber obtained from the lignin-coated bleached pulp.

From the specifications described above, the lignin-containing cellulose nanofiber according to this invention has the content of lignin, content of carboxyl group, Zeta potential and diameter in appropriate ranges. Also, in the cellulose nanofiber which comprises individualized cellulose nanofibers and cellulose nanofiber aggregates according to this invention has lignin which is appropriately dispersed both in the fiber and on the fiber surface, resulting in an advantage that when using the fiber according to this invention as the additive in paper or using (it) for producing film, which obtains the paper and the film having various improved properties as described in the above description of the invention.

### BEST MODE OF THE INVENTION

Best mode of the invention is as disclosed in the detailed description.

1. A lignin-containing cellulose nanofiber wherein:
(a) the said lignin-containing cellulose nanofiber has a content of carboxyl group in a range of 0.2-1.5 mmol/g
(b) the said lignin-containing cellulose nanofiber has Zeta potential in a range of −100 to −35 mV, and
(c) the said lignin-containing cellulose nanofiber has an average diameter in a range of 3-30 nm.

2. The cellulose nanofiber according to claim 1, wherein the said lignin-containing cellulose nanofiber preferably has the content of carboxyl group in the range of 0.4-0.7 mmol/g.

3. The cellulose nanofiber according to claim 1; wherein the said lignin-containing cellulose nanofiber preferably has Zeta potential in the range of −80 to −25 mV.

4. The cellulose nanofiber according to claim 1, wherein the said lignin-containing cellulose nanofiber preferably has the average diameter in the range of 5-21 nm.

5. The cellulose nanofiber according to claim 1, wherein the said lignin-containing cellulose nanofiber has a content of lignin in a range of 19-25% by weight, preferably in the range of 22-24% by weight.

6. The cellulose nanofiber according to claim 1, wherein the said lignin-containing cellulose nanofiber comprises individualized cellulose nanofibers having sizes ranging from 2-6 nm and cellulose nanofiber aggregates having sizes ranging from 23-32 nm.

7. The cellulose nanofiber according to claim 1, wherein the said lignin-containing cellulose nanofiber is obtained from a process comprising steps of:
(i) treating a lignin-containing cellulosic material with an organic solvent
(ii) treating the cellulosic material treated from the step (i) with derivative of N-oxy radical compound and hypochlorite compound, and
(iii) mechanical treating the cellulosic material treated from the step (ii).

8. The cellulose nanofiber according to claim 7, wherein the said lignin-containing cellulosic material is semi-chemical pulp or chemi-thermomechanical pulp having a content of lignin in a range of 25-30% by weight.

9. The cellulose nanofiber according to claim 7, wherein the said lignin-containing cellulosic material is unbleached pulp.

10. The cellulose nanofiber according to claim 7, wherein the step (i) is performed by extracting the said lignin-containing cellulosic material by using acetone as an organic solvent and washing with water.

11. The cellulose nanofiber according to claim 10, wherein washing with water is carried out at a temperature in a range of 70-100° C.

12. The cellulose nanofiber according to claim 7, wherein the step (ii) is performed by using a mole ratio of derivative of N-oxy radical compound to cellulosic material in a range of 0.15-0.25.

13. The cellulose nanofiber according to claim 7, wherein the step (ii) is performed by using a mole ratio of derivative of N-oxy radical compound to hypochlorite compound in a range of 0.15-0.25.

14. The cellulose nanofiber according to claim 7, wherein the said derivative N-oxy radical compound is derivative of 2,2,6,6-tetramethylpiperidine-1-oxy radical.

15. The cellulose nanofiber according to claim 14, wherein the said derivative of 2,2,6,6-tetramethylpiperidine-1-oxy radical is 4-acetamido-(2,2,6,6-tetramethylpiperidine-1-oxy radical.

16. The cellulose nanofiber according to claim 7, wherein hypochlorite compound in the step (ii) is alkali metal hypochlorite.

17. The cellulose nanofiber according to claim 7, wherein the step (iii) is performed by applying high shear rate to the cellulosic material obtained from the step (ii) by using high pressure homogenization.

18. Use of cellulose nanofiber according to claim 1 as an additive in a paper production process or as an additive in coating.

19. Use of cellulose nanofiber according to claim 1 for producing film.

20. A paper comprising a lignin-containing cellulose nanofiber wherein:
(a) the said lignin-containing cellulose nanofiber has a content of carboxyl group in a range of 0.2-1.5 mmol/g
(b) the said lignin-containing cellulose nanofiber has Zeta potential in a range of −100 to −35 mV, and
(c) the said lignin-containing cellulose nanofiber has an average fiber diameter in a range of 3-30 nm.

21. The paper according to claim 20, wherein the said lignin-containing cellulose nanofiber preferably has the content of carboxyl group in the range of 0.4-0.7 mmol/g.

22. The paper according to claim 20, wherein the said lignin-containing cellulose nanofiber preferably has Zeta potential in the range of −80 to −25 mV.

23. The paper according to claim 20, wherein the said lignin-containing cellulose nanofiber preferably has the average fiber diameter in the range of 5-21 nm.

24. The paper according to claim 20, wherein the said lignin-containing cellulose nanofiber has a content of lignin in a range of 19-25% by weight, preferably in the range of 22-24% by weight.

25. The paper according to claim 20, wherein the said lignin-containing cellulose nanofiber comprises individualized cellulose nanofibers having sizes ranging from 2-6 nm and cellulose nanofiber aggregates having sizes ranging from 23-32 nm.

26. The paper according to claim 20, wherein the said lignin-containing cellulose nanofiber is obtained from a process comprising steps of:
(i) treating a lignin-containing cellulosic material with an organic solvent
(ii) treating the cellulosic material treated from the step (i) with derivative of N-oxy radical compound and hypochlorite compound, and
(iii) mechanical treating the cellulosic material treated from the step (ii).

27. The paper according to claim 26, wherein the said lignin-containing cellulosic material is semi-chemical pulp or chemi-thermomechanical pulp having a content of lignin in a range of 25-30% by weight.

28. The paper according to claim 26, wherein the said lignin-containing cellulosic material is unbleached pulp.

29. The paper according to claim 26, wherein the step (i) is performed by extracting the said lignin-containing cellulosic material by using acetone as an organic solvent and washing with water.

30. The paper according to claim 29, wherein washing with water is carried out at a temperature in a range of 70-100 ° C.

31. The paper according to claim 26, wherein the step (ii) is performed by using a mole ratio of derivative of N-oxy radical compound to cellulosic material in a range of 0.15-0.25.

32. The paper according to claim 26, wherein the step (ii) is performed by using a mole ratio of derivative of N-oxy radical compound to hypochlorite compound in a range of 0.15-0.25.

33. The paper according to claim 26, wherein the said derivative of N-oxy radical is derivative of 2,2,6,6-tetramethylpiperidine-1-oxy radical.

34. The paper according to claim 33, wherein the said derivative of 2,2,6,6-tetramethylpiperidine-1-oxy radical is 4-acetamido-(2,2,6,6-tetramethylpiperidine-1-oxy radical).

35. The paper according to claim 26, wherein hypochlorite compound in the step (iii) is alkali metal hypochlorite.

36. The paper according to claim 26, wherein the step (iii) is performed by applying high shear rate to the cellulosic material obtained from the step (ii) by using high pressure homogenization.

37. The paper according to claim 20, wherein a content of the said lignin-containing cellulose nanofiber is in a range of 1-10% by weight, preferably in the range of 5-10% by weight based on dry weight of paper.

38. The paper according to claim 20 has a burst index in a range of 2.0-3.5 kPa·rn²/g.

39. The paper according to claim 20 has a tensile index in a range of 35-45 Nm/g.

40. The paper according to claim 20 has a tensile stiffness index in a range of 2,300-3,200 Nm/g.

41. A film comprising a lignin-containing cellulose nanofiber wherein:
(a) the said lignin-containing cellulose nanofiber has a content of carboxyl group in a range of 0.2-1.5 mmol/g
(b) the said lignin-containing cellulose nanofiber has Zeta potential in a range of −100 to −35 mV, and
(c) the said lignin-containing cellulose nanofiber has an average fiber diameter in a range of 3-30 nm.

42. The film according to claim 41, wherein the said lignin-containing cellulose nanofiber preferably has the content of carboxyl group in the range of 0.4-0.7 mmol/g.

43. The film according to claim 41, wherein the said lignin-containing cellulose nanofiber preferably has Zeta potential in the range of −80 to −25 mV.

44. The film according to claim 41, wherein the said lignin-containing cellulose nanofiber preferably has the average fiber diameter in the range of 5-21 nm.

45. The film according to claim 41, wherein the said lignin-containing cellulose nanofiber has a content of lignin in a range of 19-25% by weight, preferably in the range of 22-24% by weight.

46. The film according to claim 41, wherein the said lignin-containing cellulose nanofiber comprises individualized cellulose nanofibers having sizes ranging from 2-6 nm and cellulose nanofiber aggregates having sizes ranging from 23-32 nm.

47. The film according to claim 41, wherein the said lignin-containing cellulose nanofiber obtained from a process comprising steps of:
(i) treating a lignin-containing cellulosic material with an organic solvent
(ii) treating the cellulosic material treated from the step (i) with derivative of N-oxy radical compound and hypochlorite compound, and
(iv) mechanical treating the cellulosic material treated from the step (ii).

48. The film according to claim 47, wherein the said lignin-containing cellulosic material is semi-chemical pulp or chemi-thermomechanical pulp having a content of lignin in a range of 22-24% by weight.

49. The film according to claim 47, wherein the said lignin-containing cellulosic material is unbleached pulp.

50. The film according to claim 47, wherein the step (i) is performed by extracting the said lignin-containing cellulosic material by using acetone as an organic solvent and washing with water.

51. The film according to claim 50, wherein washing with water is carried out at a temperature in a range of 70-100° C.

52. The film according to claim 47, wherein the step (ii) is performed by using a mole ratio of derivative of N-oxy radical compound to- cellulosic material in a range of 0.15-0.25.

53. The film according to claim 47, wherein the step (ii) is performed by using a mole ratio of derivative of N-oxy radical compound to hypochlorite compound in a range of 0.15-0.25.

54. The film according to claim 47, wherein the said derivative of N-oxy radical compound is derivative of 2,2,6,6-tetramethylpiperidine-1-oxy radical.

55. The film according to claim 54, wherein the said derivative of 2,2,6,6-tetramethylpiperidine-1-oxy radical is 4-acetamido-(2,2,6,6-tetramethylpiperidine-1-oxy radical).

56. The film according to claim 47, wherein hypochlorite compound in the step (iii) is alkali metal hypochlorite.

57. The film according to claim 47, wherein the step (iii) is performed by applying high shear rate to the cellulosic material obtained from the step (ii) by using high pressure homogenization.

58. The film according to claim 41 has a modulus of elasticity in a range of 9-15 GPa.

59. The film according to claim 41 has a tensile strength in a range of 170-190 MPa.

60. The film according to claim 41 has a strain at break in a range of 2.0-4.0%.

61. The film according to claim 41 has an oxygen transmission rate (OTR) in a range of 5-7 cc. mm/m².day.atm at a temperature of 23° C. in a relative humidity of 90%.
